(19) United States
(12) Patent Application Publication
(10) Pub. No.: US 2007/0216631 A1
(43) Pub. Date: Sep. 20, 2007

(54) IMAGE DISPLAY DEVICE

(75) Inventor: Isao NOJIRI, Tokyo (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: MITSUBISHI ELECTRIC CORPORATION, Chiyoda-ku (JP)

(21) Appl. No.: 11/616,139

(22) Filed: Dec. 26, 2006

(30) Foreign Application Priority Data
Mar. 20, 2006 (JP) 2006-076010

(51) Int. Cl. G09G 3/36

(52) U.S. Cl. 345/100

(57) ABSTRACT

An image display device includes a liquid crystal display part, a gate line driving circuit, a source line driving circuit, and a timing controller. The source line driving circuit includes a horizontal shift register, a first latch circuit, a second latch circuit, a D/A converter circuit, and a demultiplexer capable of driving a plurality of source lines divided into a plurality of batches. The timing controller includes a pulse generating circuit, a signal transmission circuit, and a shift pulse generating circuit for generating a second latch signal and for sending a shifted start signal back to the signal transmission circuit.

### BACKGROUND OF THE INVENTION

1. Field of the Invention

The present invention relates to an image display device and, more particularly, to an image display device of a demultiplexing type.

2. Description of the Background Art

Some liquid crystal display devices and the like are of an active matrix type having pixels arranged in a matrix and constructed to drive these pixels independently. A liquid crystal display device of this active matrix type is provided with a gate line driving circuit for selecting the pixels on a row-by-row basis, and a source line driving circuit for writing gray scale data into pixels in a row selected by the gate line driving circuit. In recent liquid crystal display devices, there is a trend toward the integral formation of the gate line driving circuit and the source line driving circuit on a glass substrate formed with the pixels.

To drive the active matrix type liquid crystal display device, there is a need for a timing controller and the like for generating various timing signals for the timing control of these driving circuits, in addition to the gate line driving circuit and the source line driving circuits. Unlike the gate line driving circuit and the source line driving circuit, a circuit of the timing controller and the like has conventionally been formed on a printed circuit board by using a single crystal silicon IC and a discrete part separate from the glass substrate formed with the pixels.

However, when the timing controller and the like are formed on the printed circuit board by using the single crystal silicon IC and the discrete part in the active matrix type liquid crystal display device, the number of parts constituting a set increases, and the parts are required to be manufactured in different processes. This results in problems in hindering the reduction in the size of the set and the reduction in costs.

To solve such problems, Japanese Patent Application Laid-Open No. 2002-175026 discloses a structure in which the gate line driving circuit, the source line driving circuit and the timing controller are manufactured in the same process on the glass substrate formed with the pixels.

Further, when the source line driving circuit is formed on the glass substrate formed with the pixels, it has been difficult to reduce the size of the display device because first latch circuits, second latch circuits, D/A converter circuits and amplifiers which constitute the source line driving circuit cover a very large area. Japanese Patent Application Laid-Open No. 2001-337657 solves this problem by driving a plurality of source lines divided into a plurality of batches to reduce the number of first latch circuits, the number of second latch circuits and the number of D/A converter circuits, thereby simplifying the construction of the source line driving circuit.

In the method of driving the plurality of source lines divided into the plurality of batches as disclosed in Japanese Patent Application Laid-Open No. 2001-337657, it is however necessary to input a start signal to a horizontal shift register constituting the source line driving circuit a plurality of times within one horizontal line period. It is also necessary to input a second latch signal to the second latch circuits a plurality of times within one horizontal line period.

For this reason, a shift register constructed by connecting a plurality of flip-flops in series is used for the timing controller. The start signal generated from a horizontal synchronization signal is inputted to a first-stage flip-flop, and the shift register performs a shift operation in synchronism with a clock signal to extract the start signal and the second latch signal which are timed as required.

When the start signal and the second latch signal are generated by the timing controller constructed by simply connecting the plurality of flip-flops in series, the timing controller consumes a very large amount of electrical power. Further, shift registers equal in number to that of signals to be generated are required, and thin-film transistors are less fine in process rules than single crystal silicon. This results in the substantial layout area of the timing controller.

### SUMMARY OF THE INVENTION

It is an object of the present invention to provide an image display device having low power consumption and including a circuit for generating a start signal and a second latch signal with stability when driving a plurality of source lines divided into a plurality of batches.

According to the present invention, an image display device includes: a display part provided with a plurality of source lines arranged in a row and a plurality of gate lines arranged in a column, the display part including a pixel transistor formed near each intersection of the source lines and the gate lines; a gate line driving circuit for driving the gate lines; a source line driving circuit for driving the source lines; and a timing controller for controlling timings of the gate line driving circuit and the source line driving circuit. The source line driving circuit includes a horizontal shift register for generating a first latch signal for latching gray scale data, a plurality of first latch circuits for latching the gray scale data, based on the first latch signal from the horizontal shift register, a plurality of second latch circuits provided in corresponding relation to the plurality of first latch circuits, respectively, for latching first latch data latched by the plurality of first latch circuits simultaneously, a plurality of D/A converter circuits for converting second latch data latched by the plurality of second latch circuits into an analog gray scale voltage, and a demultiplexer for switching the supply of the analog gray scale voltage from the plurality of D/A converter circuits to the source lines so that the plurality of source lines divided into a plurality of batches are driven. The timing controller includes a pulse generating circuit for generating a start signal for the horizontal shift register from a horizontal synchronization signal, a signal transmission circuit for controlling transmission of the start signal, based on the horizontal synchronization signal, and a shift pulse generating circuit for shifting the start signal for a predetermined length of time to generate a second latch signal for controlling the plurality of second latch circuits and to send the shifted start signal back to the signal transmission circuit.

In the image display device according to the present invention, the timing controller includes the pulse generating circuit for generating the start signal for the horizontal shift register from the horizontal synchronization signal, the signal transmission circuit for controlling the transmission of the start signal, based on the horizontal synchronization signal, and the shift pulse generating circuit for shifting the start signal for the predetermined length of time to generate the second latch signal for controlling the plurality of second latch circuits and to send the shifted start signal back to the signal transmission circuit. Therefore, the image display device according to the present invention has low power consumption and is capable of generating the start signal and the second latch signal with stability when driving the plurality of source lines divided into the plurality of batches.

These and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a block diagram of an image display device according to a first preferred embodiment of the present invention;

FIG. 2 is a circuit diagram of a liquid crystal display part according to the first preferred embodiment of the present invention;

FIG. 3 is a circuit diagram of a source line driving circuit according to the first preferred embodiment of the present invention;

FIG. 4 is a circuit diagram of a horizontal shift register according to the first preferred embodiment of the present invention;

FIG. 5 is a circuit diagram of a demultiplexer according to the first preferred embodiment of the present invention;

FIG. 6 is a block diagram of a timing controller according to the first preferred embodiment of the present invention;

FIG. 7 is a block diagram of an STX and second latch signal generating circuit according to the first preferred embodiment of the present invention;

FIG. 8 is a circuit diagram of the STX and second latch signal generating circuit according to the first preferred embodiment of the present invention;

FIG. 9 is a timing chart of the image display device according to the first preferred embodiment of the present invention;

FIG. 10 is a block diagram of the image display device according to a second preferred embodiment of the present invention;

FIG. 11 is a block diagram of the timing controller according to the second preferred embodiment of the present invention;

FIG. 12 is a circuit diagram of a horizontal shift register according to the second preferred embodiment of the present invention;

FIG. 13 is a circuit diagram of a delay flip-flop according to the present invention; and

FIG. 14 is a circuit diagram of a delay latch circuit according to the present invention.

### DESCRIPTION OF THE PREFERRED EMBODIMENTS

### First Preferred Embodiment

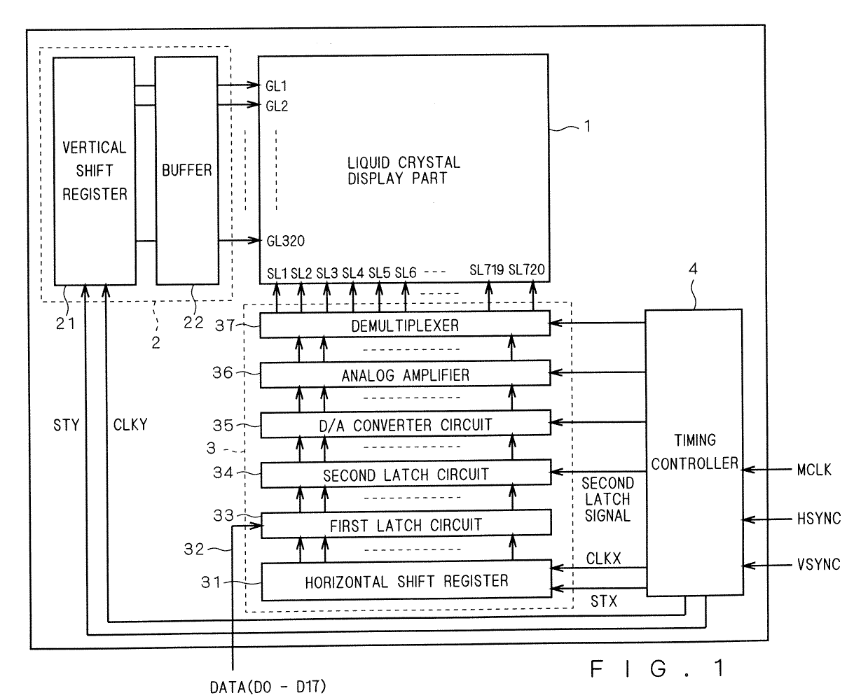

FIG. 1 is a block diagram of an image display device according to a first preferred embodiment of the present invention. The image display device shown in FIG. 1 is a thin film transistor liquid crystal display device (also referred to simply as a liquid crystal display device hereinafter). This liquid crystal display device includes a liquid crystal display part 1 having pixels (sub-pixels) arranged in a matrix (not shown), and a gate line driving circuit 2, a source line driving circuit 3 and a timing controller 4 for driving the sub-pixels. According to the present invention, the gate line driving circuit 2, the source line driving circuit 3 and the timing controller 4 are formed on the same substrate as the liquid crystal display part 1, and active elements constituting the gate line driving circuit 2, the source line driving circuit 3 and the timing controller 4 are formed by thin film transistors, as described also in the background art.

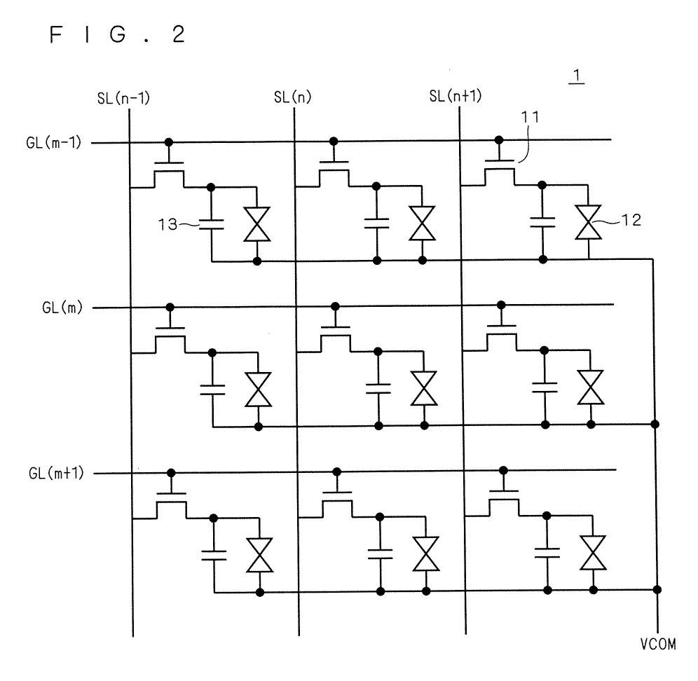

FIG. 2 is a circuit diagram of the liquid crystal display part 1. Each of the sub-pixels of the liquid crystal display part 1 shown in FIG. 2 includes a TFT (thin film transistor) 11, a liquid crystal cell 12 connected to a drain electrode (pixel electrode) of the TFT 11, and a storage capacitor 13 connected in parallel with the liquid crystal cell 12. A gate electrode of the TFT 11 provided in each sub-pixel is connected to a gate line GL (GL(m−1), GL(m), GL(m+1), . . . ) (where m is any number). A source electrode of the TFT 11 provided in each sub-pixel is connected to a source line SL (SL(n−1), SL(n), SL(n+1), . . . ) (where n is any number). A common potential Vcom is applied to a common electrode of the liquid crystal cell 12 and to the other electrode of the storage capacitor 13.

Each of the sub-pixels shown in FIG. 2 corresponds to an RGB stripe of a color filter not shown. Three sub-pixels corresponding respectively to RGB produce a color display for one pixel. Thus, when the liquid crystal display part 1 according to the first preferred embodiment has a display resolution of 240 by 320 pixels, three source lines are provided for each pixel because each pixel is composed of three sub-pixels corresponding respectively to RGB. Accordingly, the total number of source lines in the liquid crystal display part 1 according to the first preferred embodiment is 240×3=720.

Next, the gate line driving circuit 2 shown in FIG. 1 includes a vertical shift register 21, and a gate line driving buffer 22. Each gate line driving buffer 22 outputs a gate line scanning signal to each gate line GL connected thereto. Control signals such as a gate clock signal CLKY and a start signal STY are provided from the timing controller 4 to the vertical shift register 21.

The source line driving circuit 3 shown in FIG. 1 includes a horizontal shift register 31, a digital data bus line 32, a first latch circuit 33, a second latch circuit 34, a D/A converter circuit (DAC) 35, an analog amplifier (Amp.) 36, and a demultiplexer (Demux) 37. A source clock signal CLKX and a start signal STX (also referred to hereinafter as an STX signal) are provided from the timing controller 4 to the horizontal shift register 31. Digital gray scale data (D0 to D17) are provided from the outside of the image display device through the digital data bus line 32 to the first latch circuit 33.

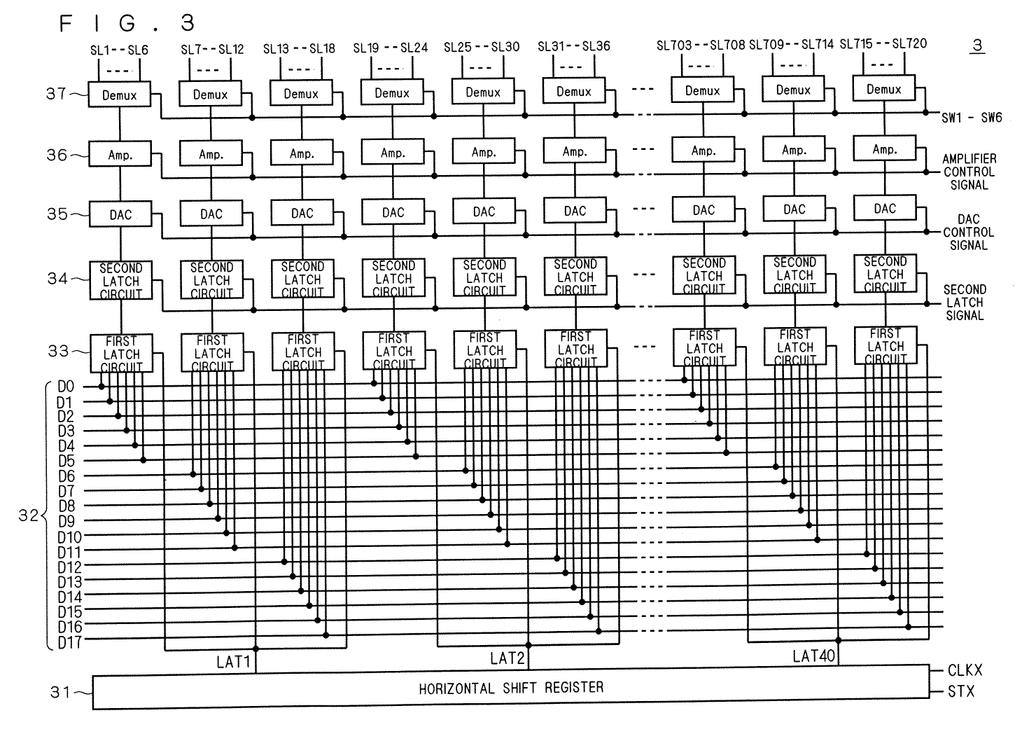

FIG. 3 is a block diagram showing the construction of the source line driving circuit 3. The source line driving circuit 3 shown in FIG. 3 includes the horizontal shift register 31, digital data bus lines 32, first latch circuits 33, second latch circuits 34, D/A converter circuits 35, analog amplifiers 36, and demultiplexers 37. In FIG. 3, 18-bit digital gray scale data (DATA: D0 to D17) are shown as inputted through the digital data bus lines 32 to the first latch circuits 33. The present invention, however, is not limited to the 18-bit digital gray scale data, and imposes no particular limitation on the number of bits of the digital gray scale data. A second latch signal is provided to the second latch circuits 34, and a DAC control signal is provided to the D/A converter circuits 35. An amplifier control signal is provided to the analog amplifiers 36, and demultiplexer control signals SW1 to SW6 are provided to the demultiplexers 37.

The source clock signal CLKX and the STX signal are provided from the timing controller 4 to the horizontal shift register 31. The horizontal shift register 31 generates first latch signals (LAT1, LAT2, . . . , LAT40) to output the first latch signals to the first latch circuits 33. According to the first preferred embodiment, 720/18=40 first latch signals are generated because the total number of source lines is 720 and the digital gray scale data is in units of 18 bits.

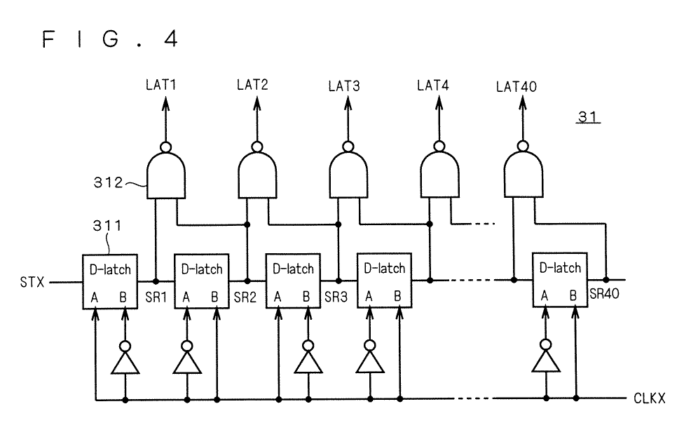

FIG. 4 is a circuit diagram of the horizontal shift register circuit 31. The horizontal shift register 31 shown in FIG. 4 includes a plurality of delay latch circuits (D-latch) 311 connected in series. The source clock signal CLKX and the inverted signal thereof are inputted to the individual delay latch circuits 311. The STX signal is inputted to a first-stage delay latch circuit 311, and an output signal from the first-stage delay latch circuit 311 is inputted to a second-stage delay latch circuit 311. In the horizontal shift register 31 shown in FIG. 4, NAND circuits 312 calculate the outputs from adjacent ones of the delay latch circuits 311, and inverted output signals from the NAND circuits 312 are outputted as the first latch signals (LAT1, LAT2, . . . , LAT40).

The first latch circuits 33 latch the digital gray scale data (DATA) based on the first latch signals from the horizontal shift register 31. The time required for the first latch circuits 33 to finish latching the digital gray scale data (DATA) for one sub-line (for one scan) is referred to as one sub-line period.

At that point in time when all of the first latch circuits 33 perform the latch operation for one sub-line, the second latch circuits 34 latch all of the outputs from the first latch circuits 33 at the same time. After the latch operation is completed in the second latch circuits 34, the first latch circuits 33 sequentially start the latch operation for the next sub-line. While the first latch circuits 33 perform the latch operation, the digital gray scale data (DATA) latched by the second latch circuits 34 is converted into an analog gray scale voltage by the D/A converter circuits 35.

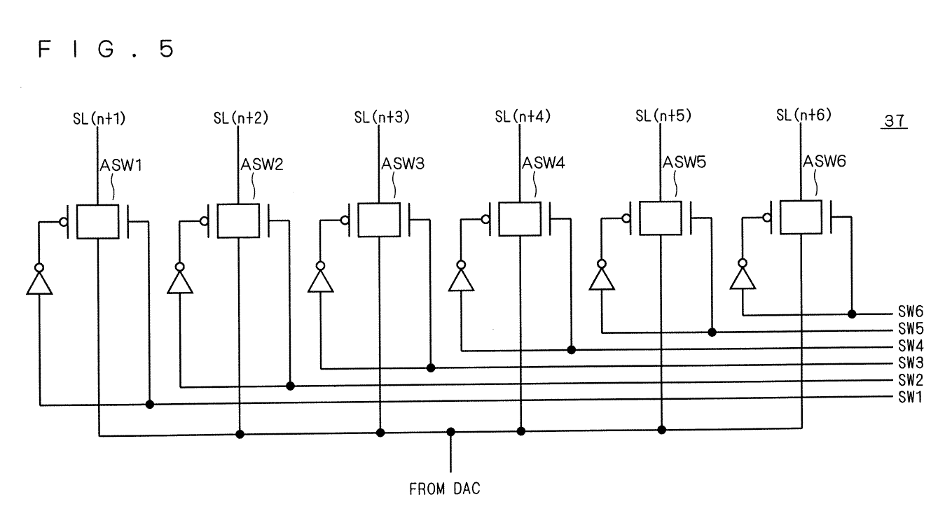

This analog gray scale voltage is provided through the analog amplifiers 36 to the demultiplexers 37. The demultiplexers 37 have a plurality of analog switches ASW for each of the D/A converter circuits 35. FIG. 5 is a circuit diagram of the demultiplexers 37. In the example shown in FIG. 3, six analog switches ASW1 to ASW6 are provided for one D/A converter circuit 35. These analog switches are connected to respective different source lines SL.

Only one of the analog switches ASW1 to ASW6 turns ON based on the demultiplexer control signals SW1 to SW6. For example, when the analog switch ASW1 turns ON, the analog gray scale voltage from a corresponding one of the D/A converter circuits 35 is provided to the source line SL connected to the analog switch ASW1. By repeating the above-mentioned operation six times, image data for one horizontal line is written into the liquid crystal display part 1. The demultiplexer 37 shown in FIG. 5 is provided with the analog switches ASW1 to ASW6 which are opened and closed by the demultiplexer control signals SW1 to SW6 and the inverted signals thereof.

Next, the timing controller 4 generates the control signals (STY, CLKY) for the gate line driving circuit 2 and the control signals for the source line driving circuit 3 from a master clock signal MCLK, a horizontal synchronization signal HSYNC and a vertical synchronization signal VSYNC which are inputted from the outside. The control signals for the source line driving circuit 3 include the control signals (STX, CLKX) for the horizontal shift register 31, the second latch signal, the DAC control signal, the amplifier control signal, and the demultiplexer control signals SW1 to SW6.

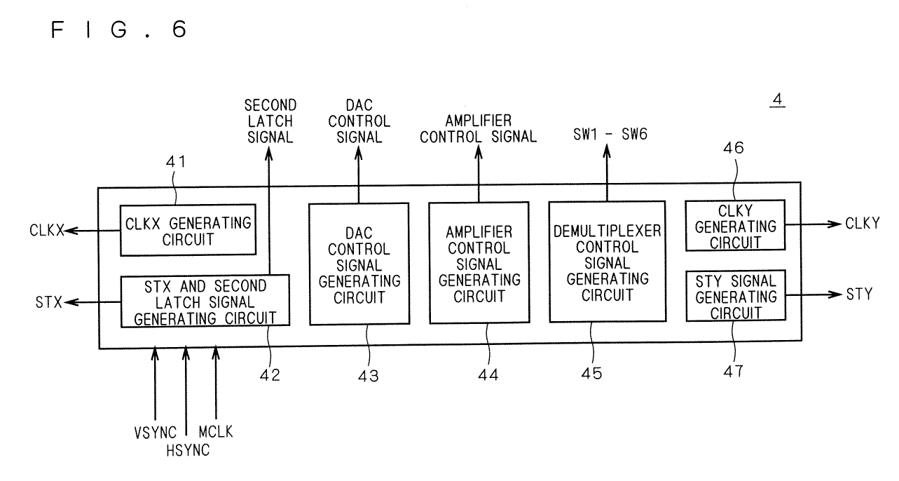

FIG. 6 is a block diagram of the timing controller 4. The timing controller 4 shown in FIG. 6 includes a CLKX generating circuit 41, an STX and second latch signal generating circuit 42, a DAC control signal generating circuit 43, an amplifier control signal generating circuit 44, a demultiplexer control signal generating circuit 45, a CLKY generating circuit 46, and an STY generating circuit 47. Typically, the master clock signal MCLK, the horizontal synchronization signal HSYNC and the vertical synchronization signal VSYNC which are inputted from the outside have a low voltage amplitude. Thus, the master clock signal MCLK, the horizontal synchronization signal HSYNC and the vertical synchronization signal VSYNC are converted to a high voltage level by a voltage converter circuit (level shifter) before being inputted to the timing controller 4. The description of the voltage converter circuit is omitted in this preferred embodiment.

The CLKX generating circuit 41 is a circuit for generating the source clock signal CLKX (referred to also as a CLKX signal hereinafter) which is provided to the horizontal shift register 31. The DAC control signal generating circuit 43 is a circuit for generating the DAC control signal which is provided to the D/A converter circuits 35 as shown in FIG. 3. The amplifier control signal generating circuit 44 is a circuit for generating the amplifier control signal which is provided to the analog amplifiers 36 as shown in FIG. 3. The demultiplexer control signal generating circuit 45 is a circuit for generating the demultiplexer control signals SW1 to SW6 which are provided to the demultiplexers 37 as shown in FIG. 3. The CLKY generating circuit 46 is a circuit for generating the gate clock signal CLKY which is provided to the vertical shift register 21. The STY generating circuit 47 is a circuit for generating the start signal STY which is provided to the vertical shift register 21.

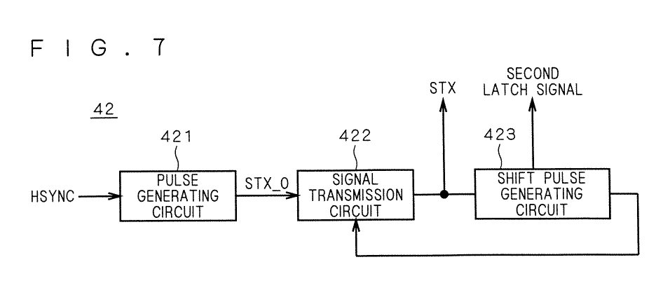

FIG. 7 is a block diagram of the STX and second latch signal generating circuit 42. The STX and second latch signal generating circuit 42 shown in FIG. 7 includes a pulse generating circuit 421, a signal transmission circuit 422, and a shift pulse generating circuit 423. The pulse generating circuit 421 generates a start signal STX_0 having a predetermined width after a lapse of a predetermined time period since the receipt of a falling edge signal or a rising edge signal for the horizontal synchronization signal HSYNC.

The signal transmission circuit 422 transmits one of the start signal STX_0 generated by the pulse generating circuit 421 or a shifted start signal sent back from the shift pulse generating circuit 423 to be described later to output the one of the signals as the STX signal to the horizontal shift register 31. The signal transmission circuit 422 may be an OR circuit, but is preferably a signal switching circuit having a switch function which will be described later.

The shift pulse generating circuit 423 receives the STX signal serving as the start signal and a predetermined number of clock signals to generate the second latch signal and a pulse signal which is sent back to the signal transmission circuit 422.

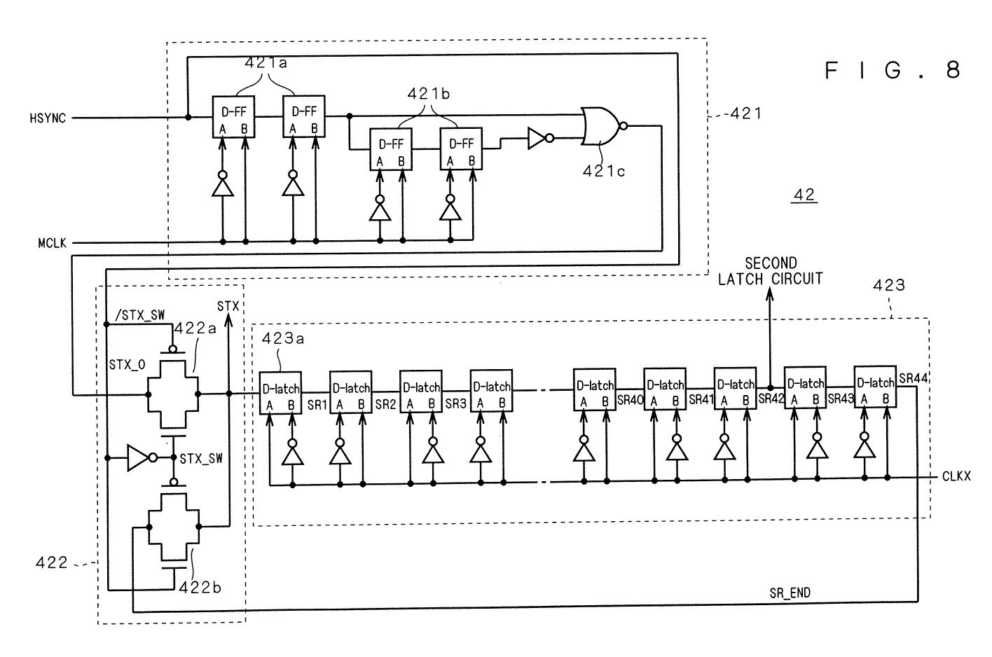

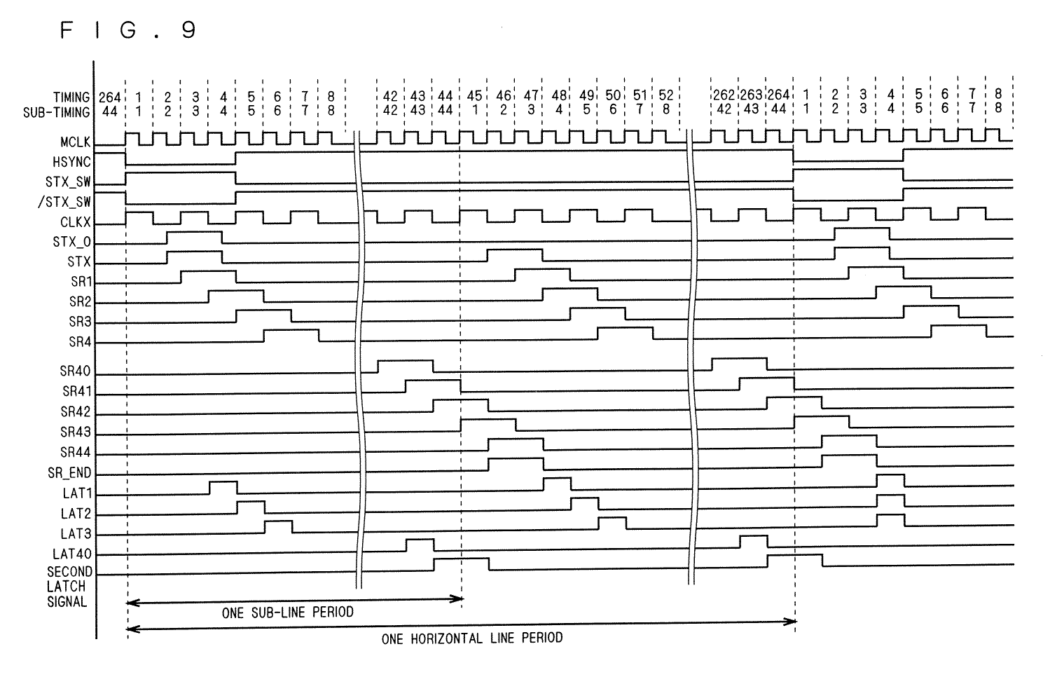

FIG. 8 is a detailed circuit diagram of the STX and second latch signal generating circuit 42. FIG. 9 is a timing chart of the image display device according to the first preferred embodiment. In FIG. 9, timings which use one horizontal line period as one cycle are denoted by timings 1 to 264. Also in FIG. 9, timings which use one sub-line as one cycle are denoted by sub-timings 1 to 44.

With reference to FIG. 9, the operation of the image display device according to the first preferred embodiment, particularly the STX and second latch signal generating circuit 42, will be described. The horizontal synchronization signal HSYNC changes from “H” to “L” with the timing 1 shown in FIG. 9. Two delay flip-flops (D-FF) 421a shown in the pulse generating circuit 421 of FIG. 8 delay the horizontal synchronization signal HSYNC by a predetermined length of time. The signal delayed by the predetermined length of time by the delay flip-flops is inputted to one of a two-input NOR circuit 421c. A signal delayed by a predetermined length of time by the delay flip-flops 421a, further delayed by a predetermined length of time by two delay flip-flops (D-FF) 421b and then inverted by an inverter is inputted to the other of the two-input NOR circuit 421c.

The master clock signal MCLK and the inverted signal thereof are inputted to the four delay flip-flops 421a,b of the pulse generating circuit 421 shown in FIG. 8. The two-input NOR circuit 421c outputs the pulse signal STX_0 having a pulse width (corresponding to two cycles of the master clock signal MCLK) delayed by the two delay flip-flops (D-FF) 421 a during the time period of the timings 3 and 4, as shown in FIG. 9.

The start signal STX-0 (referred to also as an STX_0 signal hereinafter) is inputted to the signal transmission circuit 422. The signal transmission circuit 422 according to this preferred embodiment includes a transmission gate 422a and a transmission gate 422b. The operations of the transmission gate 422a and the transmission gate 422b are controlled by a control signal /STX_SW and a control signal STX_SW which are composed of the horizontal synchronization signal HSYNC and the inverted signal thereof.

Specifically, the control signal STX_SW is “H” and the control signal /STX_SW is “L” during the time period of the timings 1 to 4 (the sub-timings 1 to 4). Thus, the transmission gate 422a of the signal transmission circuit 422 is ON, and the STX_0 signal outputted from the pulse generating circuit 421 is transmitted as the STX signal.

This STX signal passes through a buffer circuit (not shown) and is sent to the horizontal shift register 31 as the output from the timing controller 4. This STX signal is also inputted to delay latch circuits (D-latch) 423a of the shift pulse generating circuit 423. The inputted STX signal is timed to the switching to “H” and “L” of the CLKX signal inputted to each of the delay latch circuits (D-latch) 423a to cause pulse signals (SRI to SR44) to be shifted sequentially to the next-stage delay latch circuits 423a.

During the time period of the timings 44 and 45 (the sub-timings 44 and 1), the pulse signal SR42 is “H”. This signal passes through a buffer circuit (not shown) and is outputted as the second latch signal from the timing controller 4. During the time period of the timings 46 and 47 (the sub-timings 2 and 3), the pulse signal SR44 is “H”. This signal passes through a buffer circuit (not shown), and becomes a start signal which is sent back to the signal transmission circuit 422 as an SR_END signal.

During the time period of the timings 46 and 47 (the sub-timings 2 and 3), the control signal STX_SW is “L” and the control signal /STX_SW is “H”. Thus, the transmission gate 422b is ON, and the SR_END signal is transmitted as the STX signal.

Subsequently, the pulse signal SR42 is “H” and the second latch signal is outputted during the time periods of the timings 88 and 89, the timings 132 and 133, the timings 176 and 177, the timings 220 and 221, and the timings 264 and 1 (the sub-timings 44 and 1). Similarly, the signal SR44 is “H” and the SR_END signal is outputted during the time periods of the timings 90 and 91, the timings 134 and 135, the timings 178 and 179, the timings 222 and 223, and the timings 2 and 3 (the sub-timings 2 and 3). The control signal STX_SW is “L” and the control signal /STX_SW is “H” for the timings 90 and 91, the timings 134 and 135, the timings 178 and 179 and the timings 222 and 223 among the above-mentioned timings. Thus, the transmission gate 422b is ON, and the SR_END signal is transmitted as the STX signal.

On the other hand, the control signal STX_SW is “H” and the control signal /STX_SW is “L” with the timings 2 and 3. Thus, the transmission gate 422b is OFF, and the SR_END signal is not transmitted.

During the time period of the timings 2 and 3, the STX_0 signal is transmitted as the STX signal because the STX_0 signal is generated by the pulse generating circuit 421, and the transmission gate 422a is ON. The operation of the STX and second latch signal generating circuit 42 according to the first preferred embodiment is carried out by repeating the operation described above.

The first latch signals (LAT1, LAT2, . . . , LAT40) shown in FIG. 9 are signals generated by inputting the STX signal and the CLKX signal to a circuit of the horizontal shift register 31 shown in FIG. 4.

Next, the advantage of the use of the signal switching circuits (transmission gates 422a,b) having the switch function rather than the OR circuit in the signal transmission circuit 422 will be described. For example, if an instantaneous fluctuation occurs in the voltage supplied to the image display device, there is a possibility that the shift pulse generating circuit 423 malfunctions to make the pulse width of the pulse signals (SR1 to SR44) greater or to cause a normally “H” state. If the OR circuit is used in the signal transmission circuit 422, abnormal pulse signals (SR1 to SR44) continue looping between the signal transmission circuit 422 and the shift pulse generating circuit 423 to result in abnormal display.

To recover from this abnormal condition, there is a method which shuts down the power once or a method which resets the shift pulse generating circuit 423. For resetting the shift pulse generating circuit 423, however, it is necessary to have a reset function (no reset function is provided in the first preferred embodiment), and it is necessary to input a reset signal to the shift pulse generating circuit 423, thereby rebooting the display device.

However, if the signal switching circuits (the transmission gates 422a, b) are used as the signal transmission circuit 422, the signals looping between the signal transmission circuit 422 and the shift pulse generating circuit 423 are cut off when the horizontal synchronization signal HSYNC is inputted, and the new STX signal is supplied from the pulse generating circuit 421. Thus, abnormal conditions, if any, remain within one horizontal line period. Therefore, the STX and second latch signal generating circuit 42 according to the first preferred embodiment has the effect of avoiding a display abnormality due to the malfunction of the shift pulse generating circuit 423.

### Second Preferred Embodiment

The horizontal shift register 31 shown in FIG. 4 and the shift pulse generating circuit 423 shown in FIG. 8 described according to the first preferred embodiment have a commonality in having a circuit configuration such that the plurality of delay latch circuits (D-latch) 311, 423a are connected in series. It is therefore conceivable to cause circuits of the horizontal shift register 31 shown in FIG. 4 to share the function of the shift pulse generating circuit 423 shown in FIG. 8. According to a second preferred embodiment of the present invention, the image display device will be described in which the shift pulse generating circuit of the timing controller is omitted and the circuits of the horizontal shift register share the above-mentioned function.

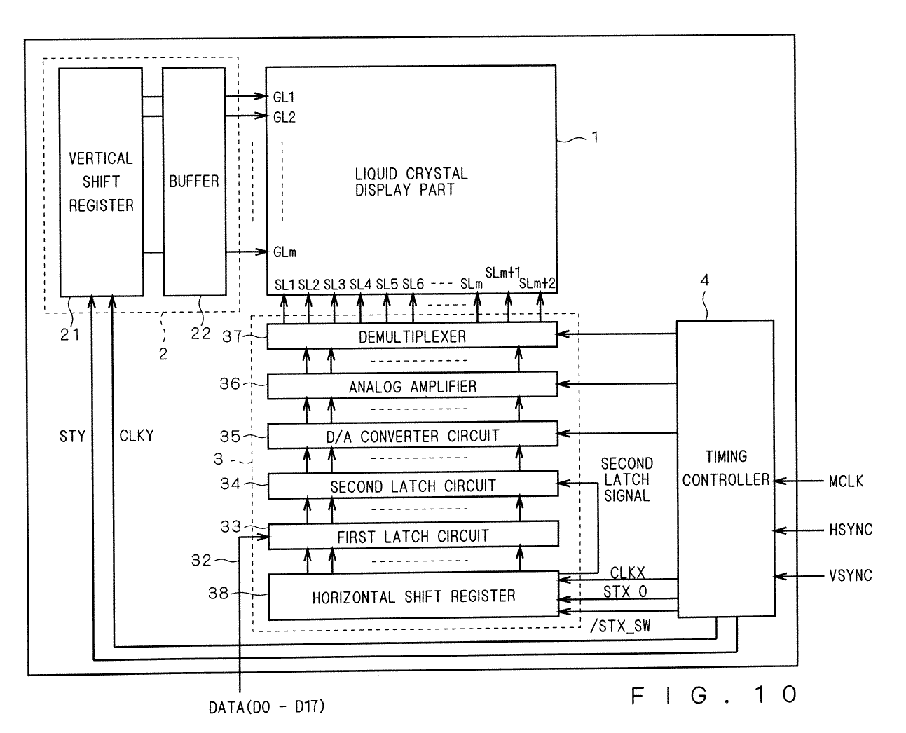

FIG. 10 is a block diagram of a liquid crystal display device which is the image display device according to the second preferred embodiment. This liquid crystal display device shown in FIG. 10 includes the liquid crystal display part 1 having pixels (sub-pixels) arranged in a matrix (not shown), and the gate line driving circuit 2, source line driving circuit 3 and timing controller 4 for driving the sub-pixels. The liquid crystal display part 1 is identical in construction with that of the first preferred embodiment. Each of the sub-pixels as shown in FIG. 2 in the liquid crystal display part 1 includes the TFT (thin film transistor) 11, the liquid crystal cell 12 connected to the drain electrode (pixel electrode) of the TFT 11, and the storage capacitor 13 connected in parallel with the liquid crystal cell 12.

Next, the gate line driving circuit 2 is also identical in construction with that of the first preferred embodiment, and includes the vertical shift register 21 for shifting the gate line scanning signal, and the gate line driving buffer 22, as shown in FIG. 10. The source line driving circuit 3 is also identical in construction with that of the first preferred embodiment, and includes a horizontal shift register 38, the digital data bus line 32, the first latch circuit 33, the second latch circuit 34, the D/A converter circuit (DAC) 35, the analog amplifier (Amp.) 36, and the demultiplexer (Demux) 37, as shown in FIG. 10.

The horizontal shift register 38 shown in FIG. 10 differs from the horizontal shift register 31 shown in FIG. 1 in that the STX_0 signal and the control signal /STX_SW are provided from the timing controller 4 to the horizontal shift register 38. Further, the horizontal shift register 38 shown in FIG. 10 generates the second latch signal to provide the second latch signal to the second latch circuit 34. That is, the horizontal shift register 38 according to the second preferred embodiment performs the function which has been performed by the STX and second latch signal generating circuit in the timing controller 4 according to the first preferred embodiment.

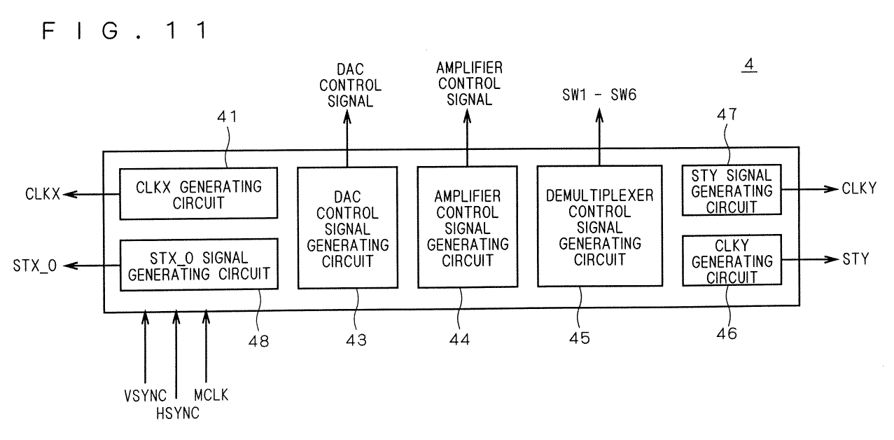

The timing controller 4 according to the second preferred embodiment, on the other hand, is constructed as shown in FIG. 11. The construction of the timing controller 4 shown in FIG. 11 is similar to that of the timing controller 4 shown in FIG. 6 except that the STX and second latch signal generating circuit 42 is replaced with an STX_0 signal generating circuit 48. Circuits other than the STX_0 signal generating circuit 48 are identical with those of the first preferred embodiment, and will not be described in detail.

The construction of the STX_0 signal generating circuit 48 is such that the signal transmission circuit 422 and the shift pulse generating circuit 423 are removed from the construction of the STX and second latch signal generating circuit 42 shown in FIGS. 7 and 8 and only the pulse generating circuit 421 remains. Thus, the STX_0 signal generating circuit 48 generates the STX_0 signal based on the master clock signal MCLK and the horizontal synchronization signal HSYNC to output the STX_0 signal to the horizontal shift register 38.

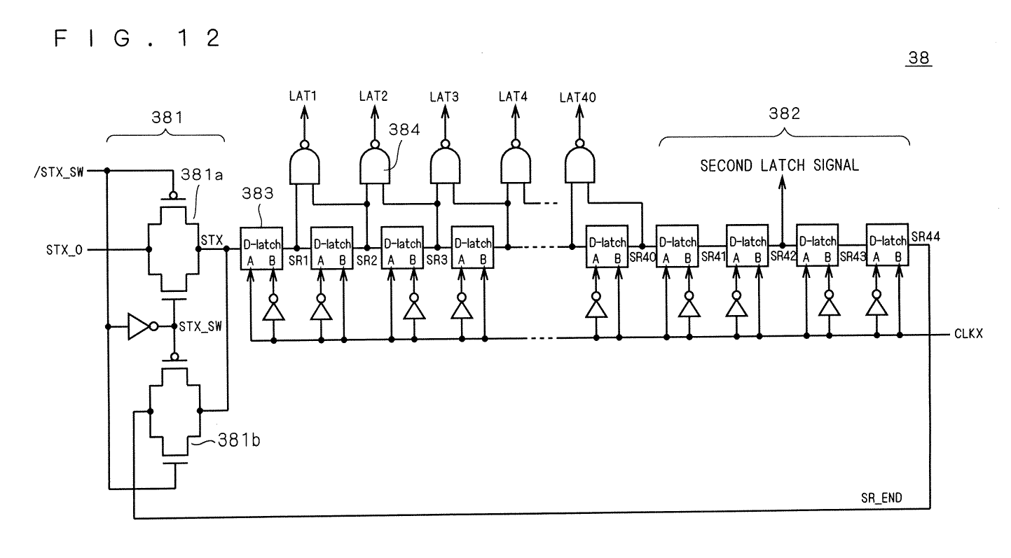

FIG. 12 is a circuit diagram of the horizontal shift register 38 according to the second preferred embodiment. The horizontal shift register 38 shown in FIG. 12 further includes a signal transmission circuit 381 and a plurality of delay latch circuits 382, as compared with the horizontal shift register 31 shown in FIG. 4. This signal transmission circuit 381 is identical in construction with the signal transmission circuit 422 shown in FIG. 8, and includes transmission gates 381a and 381b. The signal transmission circuit 381 controls the operations of the transmission gate 381a and the transmission gate 381b by using the control signal /STX_SW and the control signal STX_SW. The control signal /STX_SW and the control signal STX_SW are the horizontal synchronization signal HSYNC and the inverted signal thereof, as in the first preferred embodiment.

In the operation of the horizontal shift register 38 according to the second preferred embodiment, the STX_0 signal provided from the timing controller 4 is initially inputted to the signal transmission circuit part 381. The control signal /STX_SW provided from the timing controller 4 is further inputted to an inverter 381c, which in turn generates the inverted signal thereof, that is, the control signal STX_SW. The control signal /STX_SW and the control signal STX_SW are inputted to the transmission gate 381a and the transmission gate 381b.

The timing chart of FIG. 9 illustrated according to the first preferred embodiment will be used for the horizontal shift register 38 according to the second preferred embodiment and described. The control signal STX_SW is “H” and the control signal /STX_SW is “L” during the time period of the timings 1 to 4 (the sub-timings 1 to 4). Thus, the transmission gate 381a of the signal transmission circuit part 381 is ON, and the STX_0 signal provided from the timing controller 4 is transmitted as the STX signal.

This STX signal is inputted to delay latch circuits (D-latch) 383 connected in series. The inputted STX signal is timed to the switching to “H” and “L” of the CLKX signal inputted to each of the delay latch circuits (D-latch) 383 to be shifted as the pulse signals (SR1 to SR40) sequentially to the next-stage delay latch circuits 383. The pulse signals (SR1 to SR40) outputted from adjacent ones of the delay latch circuits 383 are inputted to two-input NAND circuits 384. Specifically, the pulse signal SR1 and the pulse signal SR2 are inputted to a NAND circuit 384, and the inverted signal of an output signal from the NAND circuit 384 becomes the first latch signal LAT1. The pulse signal SR2 and the pulse signal SR3 are inputted to a NAND circuit 384, and the inverted signal of an output signal from the NAND circuit 384 becomes the first latch signal LAT2. The first latch signals (LAT3 to LAT40) are generated similarly by repeating the similar process.

Because the four delay latch circuits 382 are added in the horizontal shift register 38, the pulse signal SR42 is “H” during the time period of the timings 44 and 45 (the sub-timings 44 and 1), and this signal passes through a buffer circuit (not shown) and is outputted as the second latch signal. Further, the pulse signal SR44 is “H” during the time period of the timings 46 and 47 (the sub-timings 2 and 3), and this signal passes through a buffer circuit (not shown), and becomes a start signal which is sent back to the signal transmission circuit 381 as the SR_END signal.

During the time period of the timings 46 and 47 (the sub-timings 2 and 3), the control signal STX_SW is “L” and the control signal /STX_SW is “H”. Thus, the transmission gate 381b is ON, and the SR_END signal is transmitted as the STX signal. Thereafter, a similar operation is repeated.

As described above, the second preferred embodiment causes the circuits of the horizontal shift register 38 to share the function of the shift pulse generating circuit for generating the start signal to be sent back to the signal transmission circuit and the second latch signal. This reduces the layout area of the timing controller 4 to further achieve the reduction in power consumption. In particular, an example in which the plurality of delay latch circuits 382 and 383 constituting the horizontal shift register 38 are shared for the generation of the start signal STX, the first latch signals and the second latch signal is illustrated according to the second preferred embodiment.

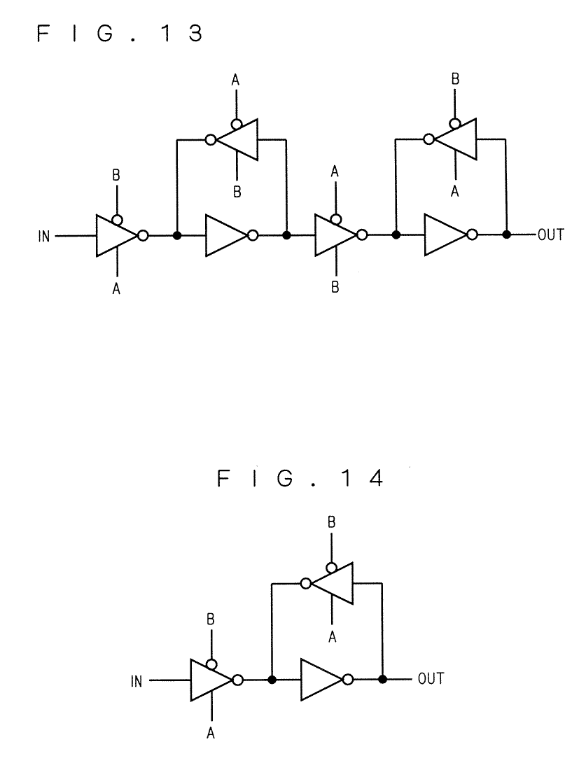

The delay flip-flops (D-FF) 421a,b used in the first and second preferred embodiments are delay flip-flops composed of a plurality of clocked inverters, and a circuit example thereof is shown in FIG. 13. The delay latch circuits (D-latch) 311, 382, 383, 423a used in the first and second preferred embodiments are delay latch circuits composed of a plurality of clocked inverters, and a circuit example thereof is shown in FIG. 14. The delay flip-flops and the delay latch circuits for use in the present invention are not limited to the clocked inverters, but may be of other constructions.

The liquid crystal display device is illustrated as an example of the image display device according to the first and second preferred embodiments. The present invention, however, is not limited to this, but may be an image display device having a display part provided with a plurality of source lines arranged in a row and a plurality of gate lines arranged in a column, and formed with a pixel transistor near each of the intersections of the source lines and the gate lines. For example, organic EL of an active matrix type and the like may be applied to the image display device of the present invention.

While the invention has been described in detail, the foregoing description is in all aspects illustrative and not restrictive. It is understood that numerous other modifications and variations can be devised without departing from the scope of the invention.

What is claimed is:

1. An image display device comprising:
a display part provided with a plurality of source lines arranged in a row and a plurality of gate lines arranged in a column, said display part including a pixel transistor formed near each intersection of said source lines and said gate lines;
a gate line driving circuit for driving said gate lines;
a source line driving circuit for driving said source lines; and
a timing controller for controlling timings of said gate line driving circuit and said source line driving circuit,
said source line driving circuit including
a horizontal shift register for generating a first latch signal for latching gray scale data,
a plurality of first latch circuits for latching said gray scale data, based on said first latch signal from said horizontal shift register,
a plurality of second latch circuits provided in corresponding relation to said plurality of first latch circuits, respectively, for latching first latch data latched by said plurality of first latch circuits simultaneously,
a plurality of D/A converter circuits for converting second latch data latched by said plurality of second latch circuits into an analog gray scale voltage, and
a demultiplexer for switching the supply of said analog gray scale voltage from said plurality of D/A converter circuits to said source lines so that said plurality of source lines divided into a plurality of batches are driven,
said timing controller including
a pulse generating circuit for generating a start signal for said horizontal shift register from a horizontal synchronization signal,
a signal transmission circuit for controlling transmission of said start signal, based on said horizontal synchronization signal, and
a shift pulse generating circuit for shifting said start signal for a predetermined length of time to generate a second latch signal for controlling said plurality of second latch circuits and to send said shifted start signal back to said signal transmission circuit.

2. An image display device comprising:
a display part provided with a plurality of source lines arranged in a row and a plurality of gate lines arranged in a column, said display part including a pixel transistor formed near each intersection of said source lines and said gate lines;
a gate line driving circuit for driving said gate lines;
a source line driving circuit for driving said source lines; and
a timing controller for controlling timings of said gate line driving circuit and said source line driving circuit,
said source line driving circuit including
a horizontal shift register for generating a first latch signal for latching gray scale data,
a plurality of first latch circuits for latching said gray scale data, based on said first latch signal from said horizontal shift register,
a plurality of second latch circuits provided in corresponding relation to said plurality of first latch circuits, respectively, for latching first latch data latched by said plurality of first latch circuits simultaneously,
a plurality of D/A converter circuits for converting second latch data latched by said plurality of second latch circuits into an analog gray scale voltage, and
a demultiplexer for switching the supply of said analog gray scale voltage from said plurality of D/A converter circuits to said source lines so that said plurality of source lines divided into a plurality of batches are driven,
said timing controller including
a pulse generating circuit for generating a start signal for said horizontal shift register from a horizontal synchronization signal,
said horizontal shift register including
a signal transmission circuit for controlling transmission of said start signal, based on said horizontal synchronization signal, and
a circuit part for shifting said start signal for a predetermined length of time to generate said first latch signal for latching said gray scale data and a second latch signal for controlling said plurality of second latch circuits and to send said shifted start signal back to said signal transmission circuit.

3. The image display device according to claim 1, wherein
said signal transmission circuit is a signal switching circuit having a switch function such that opening and closing thereof are controlled based on said horizontal synchronization signal.

4. The image display device according to claim 2, wherein
said signal transmission circuit is a signal switching circuit having a switch function such that opening and closing thereof are controlled based on said horizontal synchronization signal.

5. The image display device according to claim 3, wherein
said signal switching circuit includes a plurality of transmission gates.

6. The image display device according to claim 4, wherein
said signal switching circuit includes a plurality of transmission gates.

7. The image display device according to claim 1, wherein
said shift pulse generating circuit includes a plurality of delay latch circuits.

8. The image display device according to claim 2, wherein
said circuit part of said horizontal shift register includes a plurality of delay latch circuits shared for generation of said first latch signal and said second latch signal.

9. The image display device according to claim 1, wherein
active elements constituting said gate line driving circuit, said source line driving circuit and said timing controller are thin film transistors.

10. The image display device according to claim 2, wherein
active elements constituting said gate line driving circuit, said source line driving circuit and said timing controller are thin film transistors.
